(19) United States
(12) Patent Application Publication
(10) Pub. No.: US 2013/0186361 A1
(43) Pub. Date: Jul. 25, 2013

(54) COOLING DEVICE FOR A LASER SPARK PLUG

(71) Applicants: Karl-Heinz Nuebel, Simmozheim (DE); Pascal Woerner, Korntal-Muenchingen (DE); Juergen Raimann, Weil Der Stadt (DE); Rene Hartke, Stuttgart (DE); Martin Weinrotter, Vitoria-Gasteiz (ES)

(72) Inventors: Karl-Heinz Nuebel, Simmozheim (DE); Pascal Woerner, Korntal-Muenchingen (DE); Juergen Raimann, Weil Der Stadt (DE); Rene Hartke, Stuttgart (DE); Martin Weinrotter, Vitoria-Gasteiz (ES)

(21) Appl. No.: 13/811,073

(22) PCT Filed: May 18, 2011
(86) PCT No.: PCT/EP2011/058058

§ 371 Date: Mar. 29, 2013

(30) Foreign Application Priority Data
Jul. 21, 2010 (DE) 10 2010 031 598.2

(51) Int. Cl. F02P 23/04

(52) U.S. Cl. CPC F02P 23/04
USPC 123/143 B

(57) ABSTRACT

A cooling device for a laser spark plug. The cooling has a radially inner first contact area which is developed to establish a thermal contact to a housing of the laser spark plug via at least one first radially inner contact surface. The cooling device also has a radially outer second contact area which is developed to establish a thermal contact to a heat sink, in particular to an inner wall of a spark plug hole receiving the laser spark plug, via at least one first radially outer contact surface. A connector is provided, which is developed to establish a thermal contact between the first contact area and the second contact area. The cooling device is developed at least in part elastically in order to allow for a relative movement in a generally radial direction between at least the first contact surface and the second contact surface.

### FIELD OF THE INVENTION

The present invention relates to a cooling device for a laser spark plug, in particular for a laser spark plug of an internal combustion engine.

### BACKGROUND INFORMATION

A cooling of a laser spark plug is described in European Patent No. EP 1 519 038 A1, in which positive cooling is achieved by a fluid circulating in a cooling circuit. This cooling principle necessitates a very great expenditure in terms of manufacturing technology and also very great precision in assembly. Furthermore, the described system requires a relatively large installation space.

### SUMMARY

Accordingly, it is an object of the present invention to provide a cooling device for a laser spark plug, which requires relatively little constructional expenditure, is simple to install and may also be used in situations where there is limited installation space.

According to an example embodiment of the present invention, a cooling device is provided that has a radially inner first contact area, which is developed to establish a thermal contact to a housing of the laser spark plug via at least one first radially inner contact surface. The cooling device also has a radially outer second contact area, which is developed to establish a thermal contact to a heat sink, in particular to an inner wall of a spark plug hole receiving the laser spark plug, via at least one first radially outer contact surface, and a connector which establishes a thermal contact between the first contact area and the second contact area. The cooling device is developed at least in part elastically in order to allow for a relative movement in a generally radial direction between at least the first contact surface and the second contact surface.

The example embodiment of the present invention may advantageously allow for efficient heat conduction between the contact areas via the connector that is preferably formed from highly heat-conductive material. The material defining the contact areas is preferably also highly heat-conductive.

The elasticity acting at least in the radial direction advantageously allows for the manufacture of particularly efficient heat-conducting contacts in the area of the inner contact surface and the outer contact surface such that the occurrence of air gaps impairing the heat conduction between the laser spark plug and the heat sink is mostly avoided.

In particular, the elasticity of the cooling device advantageously results in contact pressure acting generally in the radial direction, which in the installed state of the cooling device on a laser spark plug situated in a spark plug hole effects a good thermal contact between the contact areas and the opposite surfaces of the laser spark plug and the heat sink.

“Elasticity” in the present context is understood as the property of allowing for a relative movement in the generally radial direction between at least the first contact surface and the second contact surface. Depending on the construction of the cooling device, this elasticity may be effected directly by a corresponding property of the utilized material (e.g., elastic heat-conducting silicone). Furthermore, any construction of the cooling device is also regarded as “elastic” in the sense of the present invention, which allows for the radial force effect described above, thus in particular also constructions containing spring mechanisms, in which the contact areas are pressed apart in a corresponding fashion via spring forces in an essentially radial direction. In these constructions, the “elasticity” is therefore not determined primarily from the property of the utilized materials, but rather via the spring force effects resulting from the construction.

According to an advantageous specific embodiment, a particularly large surface of the first radially inner contact surface results if the first contact area has at least partially a generally hollow cylindrical basic shape, the cooling device surrounding the laser spark plug or its housing in the installed state. In a circular-cylindrically developed housing of the laser spark plug, the entire part of the jacket surface of the circular-cylindrically formed housing of the laser spark plug, which is covered by the inner contact surface of the cooling device, is also efficacious for conducting heat away from the laser spark plug to the heat sink.

A similarly favorable, large, radially inner contact surface results if the first contact area has at least in part an essentially (hollow) conical basic shape. A housing segment of the laser spark plug that interacts with the cooling device is accordingly also conically shaped. Compared to the hollow-cylindrical design, the conical design has the advantage that an axial bracing of the cooling device against the housing of the laser spark plug, for example by a screw cap or a spring mechanism, allows for a close surface contact of the radially inner contact surface and the respective surface areas of the laser spark plug housing, which further reduces the risk of the formation of air gaps.

Another preferred specific embodiment provides for a radially outer contact surface of the second contact area to be greater than or equal to a radially inner contact surface of the first contact area. This makes it possible to compensate for a possibly worse heat transfer between the second contact area and the heat sink—compared to the first contact area—by the greater area.

Particularly advantageously, the first contact area, the second contact area and the connector may be developed from the same material, preferably from a highly heat-conductive material such as, for example, copper or aluminum or silver or suitable alloys thereof. An integral development of the cooling device or its components from such a material is preferred. The cooling device may alternatively or additionally also have heat pipes for developing and supplementing or connecting the two contact areas.

Another advantageous specific embodiment provides for a radially inner surface of the second contact area to have springs at least partially acting in the radial direction, which are developed and arranged in such a way that they apply a spring force on the second contact area against the first contact area and/or in the installation position of the cooling device against a housing of the laser spark plug, whereby the elastic development of the cooling device according to the present invention is enhanced further. In particular, providing these additional springs advantageously makes it possible to use a highly heat-conductive material such as copper, for example, for developing the actual cooling device (heat-conducting contact areas and connecting means), while a material such as spring steel, for example, which is optimized with respect to the required spring properties, may be used for the additional spring. In this case, the elasticity of the cooling device according to the present invention is significantly influenced by the additional spring, while at the same time a material optimized for thermal conductivity is provided for developing the inner and outer contact areas and the connecting means, which possibly has less favorable spring properties than the material of the additional spring.

Another advantageous variant of the cooling device of the present invention provides for the cooling device to be developed at least in sections as a stuffing box, a packing of the stuffing box being made up of an elastic heat-conductive material, which forms at least in part the first contact area and/or the second contact area and/or the connector. In this case, a radial evading movement of the elastic heat-conductive material may be effected in a conventional manner by axially bracing two end faces of a housing unit defining the volume of the stuffing box, which elastic heat-conductive material contacts the radially opposite surface areas of the laser spark plug and of the heat sink as a consequence of the application of the axial pressure.

Instead of using an elastic heat-conductive material such as heat-conductive silicone, for example, or a metal meshwork, in particular a copper meshwork, a material mix of a highly heat-conductive material such as stranded copper wire or a copper meshwork and an additional material having elastic properties may be used as well.

The combination of the stuffing box principle described above and other elements providing the elasticity required by the present invention is also possible, a first axial section of the cooling device according to the present invention having for example a stuffing box, and another axial section of the cooling device according to the present invention having for example contact areas or contact surfaces formed of highly heat-conductive copper.

In another specific embodiment of the present invention, the cooling device may be provided particularly advantageously with a slot, which allows for a subsequent mounting of the cooling device on a laser spark plug installed in an internal combustion engine. The slot in this case advantageously extends in parallel to the longitudinal direction of the laser spark plug and is sufficiently wide that the cooling device according to the present invention may be plugged over one or more cables supplying the laser spark plug with laser light or control signals. Subsequently, the cooling device may be plugged onto the laser spark plug by an axial relative movement. When using a slotted hollow cylindrical radial inner contact area, the inner radius of the hollow cylinder of the cooling device is preferably selected to be somewhat smaller than the outer radius of the corresponding housing section of the laser spark plug in order for the cooling device to be fully resting in the area of the first radial inner contact surface.

This slot may also be provided in the case of a radially inner first contact area that is conical or developed in another manner.

In order to allow for a particularly good thermal conductivity from the radially outer second contact area to the heat sink, the at least one first radially outer contact surface has at least in sections a surface shape corresponding generally to a lateral surface of a circular cylinder. This is particularly advantageous since conventional spark plug holes, which accommodate the laser spark plug in its installed state in the region of an internal combustion engine, normally represent circular-cylindrical cavities.

A particularly simple installation, in particular an insertion of the cooling device into a spark plug hole, is possible according to another advantageous specific embodiment of the present invention because the radially outer contact area has an axial end section, which points radially inward in such a way that its longitudinal axis encloses an angle between approximately 2° and approximately 45° with a longitudinal axis of the laser spark plug. This means that the axial end section of the radially outer contact area, by which the cooling device is first inserted into the spark plug hole, is preferably bent slightly into a radially inner direction in order to allow for easier insertion. The installation may be further supported by a corresponding shaping of the end faces of the axial end regions, for example, by rounding them off or the like.

In a specific embodiment of the cooling device according to the present invention, which is particularly favorable from the perspective of manufacturing technology, the radially outer contact area is formed by a plurality of arm-shaped and/or U-shaped structures. In this case, the cooling device according to the present invention may be manufactured in a particularly simple manner using a rectangular sheet metal, for example a copper sheet. For instance, a comb-like structure may first be produced from the rectangular copper sheet by stamping, and subsequently the individual arms of the comb-like structure may be bent with respect to the initial plane of the copper sheet in such a way that a specifiable longitudinal section of the arms are in a plane that is parallel to the initial plane. Subsequently, the non-punched area may be bent into a circular shape such that a generally rotationally symmetrical arrangement results.

Alternatively, the outer contact are may also have U-shaped arms.

It is particularly advantageous if the surface regions of the arm-shaped or U-shaped structures, which contact the heat sink, are adapted in terms of shape to the heat sink.

For example, the respective surface of an arm-shaped structure may correspond essentially to a lateral surface of a circular cylinder, the radius of which approximately agrees with the inner radius of a spark plug hole accommodating the laser spark plug.

Further advantages, features and details result from the following description, in which different exemplary embodiments of the present invention are shown with reference to the figures. In this context, the features mentioned in the claims and the description may be used in accordance with the present invention either individually in isolation, or in any combination.

### BRIEF DESCRIPTION OF THE DRAWINGS

FIG. 1 shows a schematic representation of a laser spark plug in a spark plug hole of an internal combustion engine having a cooling device according to a first specific embodiment.

FIG. 2a shows a partial cross section of additional specific embodiments of the cooling device according to the present invention.

FIGS. 2b-2e show additional specific embodiments of the cooling device according to the present invention, respectively in a detailed view.

FIG. 3a shows a partial cross section of another specific embodiment of the cooling device.

FIG. 3 shows a partial cross section of yet another specific embodiment of the cooling device.

FIG. 3c shows a partial cross section of an arm-shaped structure of the specific embodiment according to FIG. 3a.

FIG. 4 shows a perspective view of an additional specific embodiment of the cooling device.

FIG. 5 shows a perspective view of another specific embodiment of the cooling device.

FIG. 6 shows a specific embodiment of the cooling device according to the present invention, which operates according to the stuffing box principle.

### DETAILED DESCRIPTION OF EXAMPLE EMBODIMENTS

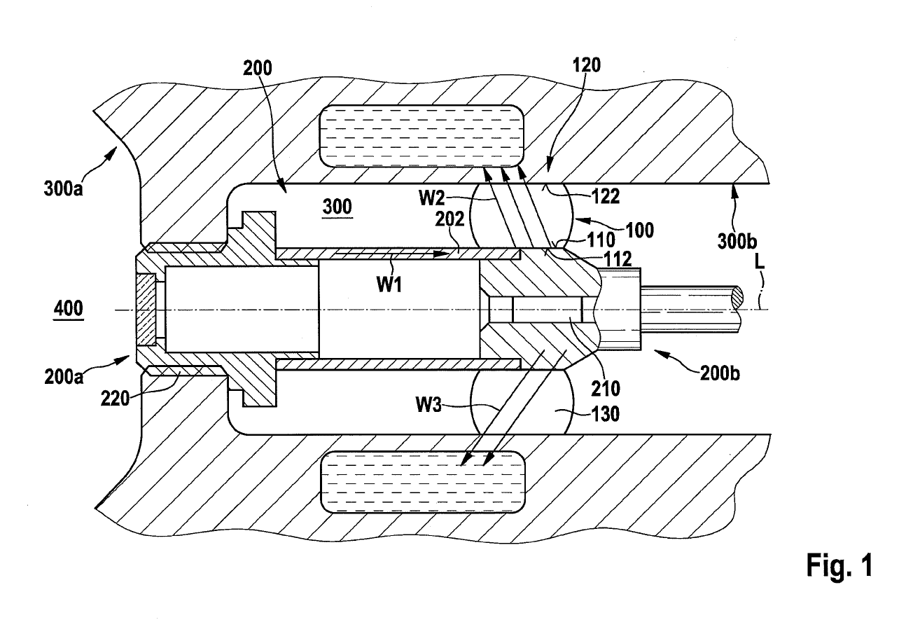

FIG. 1 shows schematically a partial cross section of a laser spark plug 200 in its installed state in a spark plug hole 300 of a cylinder head area 300a of an internal combustion engine, which may be for example an internal combustion engine of a motor vehicle or a stationary large gas engine or the like.

While the internal combustion engine is in operation, an undesired heat input occurs in a conventional manner from the combustion chamber 400 of the internal combustion engine, depicted in FIG. 1 on the left, first into the combustion-chamber side end area 200a of the laser spark plug.

Furthermore, another heat input into laser spark plug 200 occurs through a laser device 210 situated in laser spark plug 200. Cylinder head 300a of the internal combustion engine has one or more cooling ducts in a conventional manner, through which a cooling fluid, in particular cooling water, circulates, whereby cylinder head 300a is cooled. Laser spark plug 200 is connected to cylinder head 300a for example via a screw connection 220. Because of the relatively good heat transfer in the area of screw connection 220, laser spark plug 200 is able to give off at least part of the heat coming from combustion chamber 400 directly to cylinder head 300a. This does not apply, however, to heat quantities which enter laser spark plug 200 due to the operation of laser device 210.

Since the heat input through laser device 210 is usually markedly lower than through combustion chamber 400, there results additionally an undesired heat flow W1 in laser spark plug 200 from the combustion-chamber side end area 200a in FIG. 1 towards the right, i.e., towards the end area 200b of laser spark plug 200 facing away from the combustion chamber.

The present invention provides a cooling device 100 for the efficient cooling of laser spark plug 200.

Cooling device 100 has a radially inner first contact area 110, which is developed to establish a thermal contact to housing 202 of laser spark plug 200 via at least one first radially inner contact surface 112.

Cooling device 100 additionally has a radially outer second contact area 120, which is developed to establish a thermal contact to a heat sink, in the present case in particular to inner wall 300b of spark plug hole 300 or cylinder head 300a, via a radially outer contact surface 122.

According to the present invention, cooling device 100 further has connectors 130, which in the present case are situated radially between first contact area 110 and second contact area 120 and are developed to establish a thermal contact between first contact area 110 and second contact area 120 such that a heat conduction occurs from first contact area 110 to the second contact area.

According to the present invention, cooling device 100 is developed to be at least partly elastic in order to allow for a relative movement in the radial direction between at least first contact surface 112 and second contact surface 122, which results in a particularly good thermal contact between housing 202 of laser spark plug 200 and the inner surface of spark plug hole 300 due to corresponding radially acting forces in the elastic deformation. That is to say, when correctly dimensioned, in particular when correctly adapted in its geometry to the distance between housing 202 and inner surface 300b, the elasticity of cooling device 100 provides for a radially acting force, which presses contact surfaces 112, 122 onto their contact partners 202, 300b and thus ensures a good heat conduction since in this manner particularly air gaps between the surfaces are largely avoided.

Consequently, the heat flow symbolized in FIG. 1 by the corresponding arrows W2, W3 sets in from housing 202 of laser spark plug 200 into cylinder head 300a or its cooling ducts.

The elastic properties of cooling device 100 advantageously also provide for a tolerance equalization between the geometry of cooling device 100 and the geometry of spark plug hole 300 as well as the geometry of housing 202 of laser spark plug 200.

In order to implement the elasticity according to the present invention, it is not necessary for the entire cooling device 100 or the material that forms it to be developed elastically. It furthermore suffices entirely if the connecting area or connecting means 130 situated radially between the radially inner first contact area 110 and the radially outer second contact area 120 is/are developed elastically in order to apply a corresponding radially counteracting force between first contact area 110 and second contact area 120. The required radial application of force may also be achieved by providing spring means such as, e.g., bent metal strips etc., which are at the same time used to transfer heat between components 110, 120.

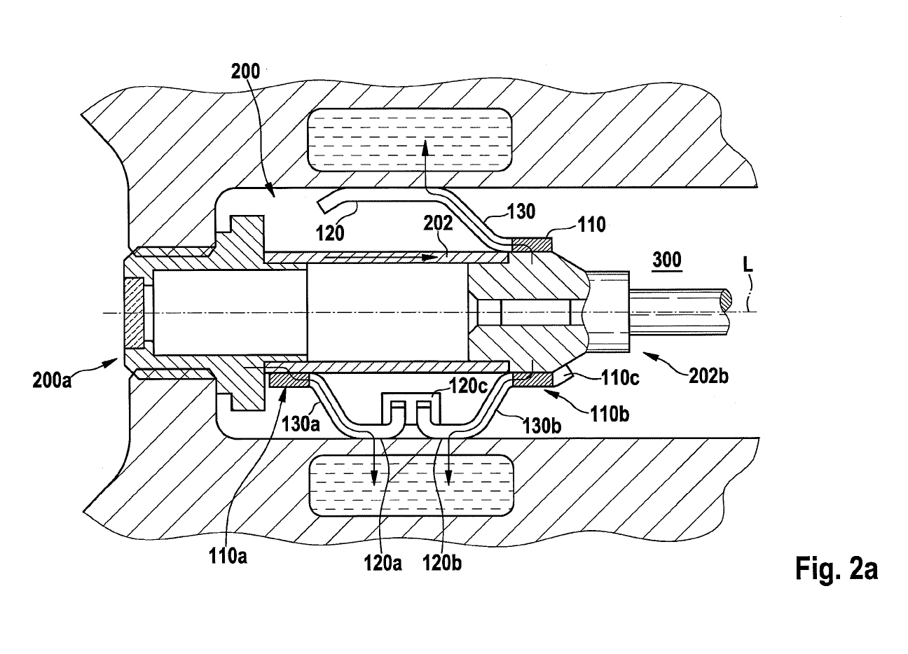

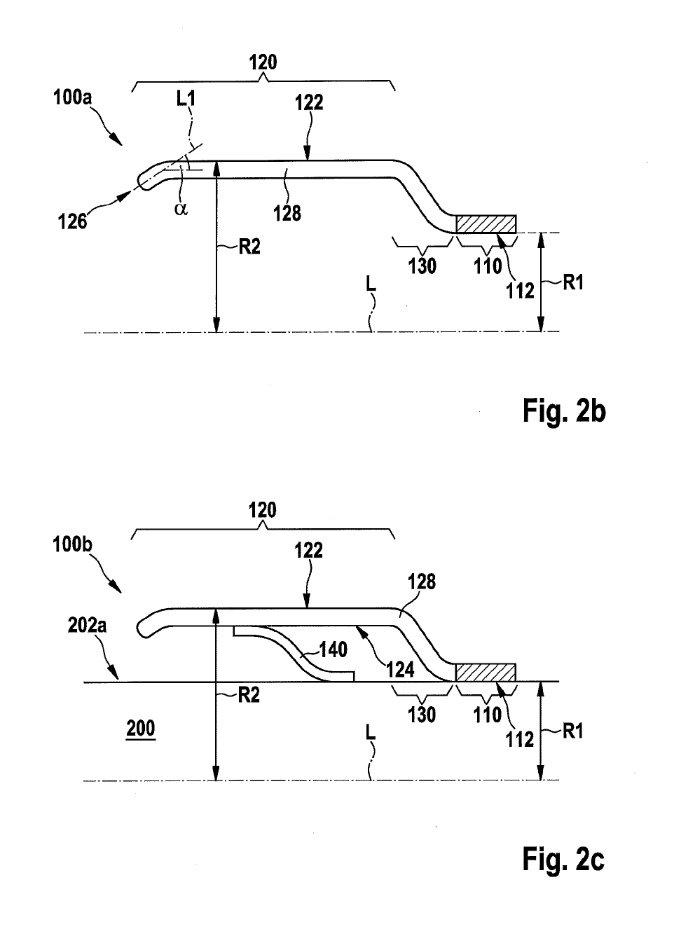

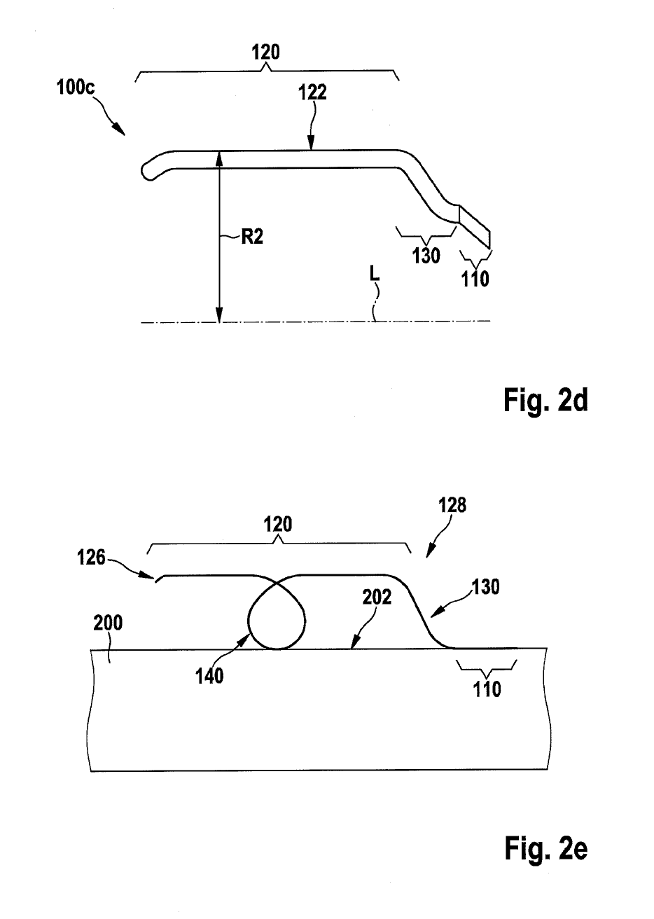

Particularly advantageously, the outer diameter R2 (FIG. 2b) and inner diameter R1 of cooling device 100 are adapted in such a way to the geometry of laser spark plug 200 and spark plug hole 300 that cooling device 100 is slightly pressed radially during installation in order to promote the above-described contact mechanisms favoring heat conduction.

In a representation shown above longitudinal axis L of laser spark plug 200, FIG. 2a shows another variant of the cooling device 100 of the present invention, in which the radially inner first contact area 110 has a generally hollow-cylindrical form and is pushed in the axial direction over housing 202 of laser spark plug 200. In the present case, the radially outer second contact area 120 is implemented by a plurality of arm-shaped structures, of which only one is represented on top in FIG. 2. With its greatest longitudinal section extending in parallel to longitudinal axis L, the arm-shaped structure rests fully on an inner surface of spark plug hole 300 in order to establish good thermal contact. In this specific embodiment, the elasticity or spring force effect is implemented by the bent section of connector 130.

FIG. 2b shows an arm-shaped structure 128 of a specific embodiment of cooling device 100a in detail. In order to facilitate the insertion of cooling device 100a into spark plug hole 300 (FIG. 2a), an axial front area 126 may be bent off radially inward and possibly also be rounded off. Area 126 is preferably developed in such a way that its longitudinal axis L1 in the installed state on laser spark plug 200 encloses an angle alpha of about 2° to about 45° with the longitudinal axis L of laser spark plug 200.

FIG. 2c shows an arm-shaped structure 128 of another specific embodiment of cooling device 100b in detail. As may be seen from FIG. 2c, a radially inner surface 124 of second contact area 120 may have springs 140 acting at least partially in the radial direction, i.e., vertically in FIG. 2c, which are developed and situated in such a way that they apply a spring force on second contact area 120 against first contact area 110 and/or in the installed state of cooling device 100 against a housing 202 of laser spark plug 200. In the present case, the spring 140 developed as a flat spring are supported on inner surface 124 of second contact area 120 and on outer surface 202a of laser spark plug 200.

Particularly advantageously, spring 140 may be developed from a different material than the remaining components 110, 120, 130 of cooling device 100b such that a respective functional optimization is possible. For example, the heat-conducting components 110, 120, 130 may be developed, preferably as one piece, from a highly heat-conductive material such as copper, for example, while spring 140 may be developed from a material optimized for the spring effect such as spring steel, for example. Preferably, spring 140 may be developed as a flat spring.

An integration of spring 140 with components 110, 120, 130 in one piece is also possible; compare the lateral view of another specific embodiment of the arm-shaped structure 128 as shown in FIG. 2e.

FIG. 2d shows another variant 100c of the cooling device, in which first contact area 110 is developed conically and is able to be pressed together axially with a conical outer surface of laser spark plug 200 e.g. by a corresponding clamping nut (not shown).

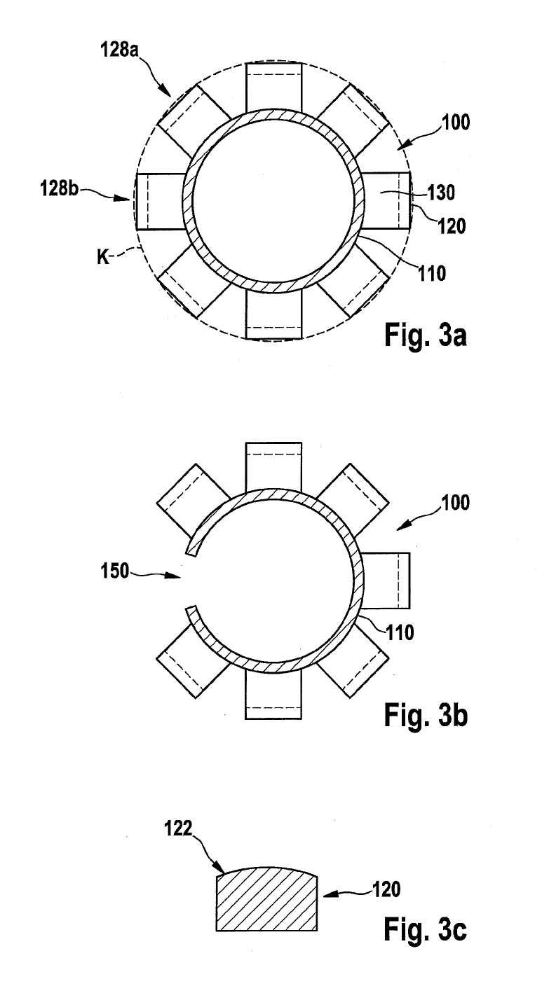

FIG. 3a shows a partial cross section through the specific embodiment of cooling device 100 described above with reference to the upper half of FIG. 2a. The hollow-cylindrical, radially inner, first contact area 110 is surrounded by 8 structures 128a, 128b, . . . , which are arm-shaped in the present example, and which are—like connector 130—advantageously developed in one piece with first contact area 110. As shown in FIG. 3a, a first bent-off area of arm-shaped structure 128a, 128b, . . . forms the connector 130 between inner contact area 110 and outer contact area 120. The remaining longitudinal section of the arm-shaped structures extends into the drawing plane of FIG. 3a and has a longitudinal axis, which—at least in the installed state—is situated approximately in parallel to longitudinal axis L of laser spark plug 200 (FIG. 2a). Dashed circular line K in FIG. 3a indicates a geometry of spark plug hole 300 (FIG. 2a). An optimized surface contact or thermal contact between arm-shaped structures 128a, 128b, . . . and spark plug hole 300 may be effected advantageously by developing the cross section of arm-shaped structures 128a, 128b, . . . in accordance with FIG. 3c, which means that radially outer contact surface 122 of the arm-shaped structure or of the second contact area 120 formed by it has a radius of curvature that is adapted to the radius of curvature of spark plug hole K (FIG. 3a).

FIG. 3b shows another variant of a cooling device 100 according to the present invention, in which the generally likewise hollow-cylindrically developed radially inner first contact area 110 has a slot 150, which allows for the subsequent mounting of cooling device 100 on an already installed laser spark plug 200 because connecting cables leading to laser spark plug 200 may be guided simply through slot 150. In particular, slot 150 is therefore to be chosen to be of such a size that it is greater than the outer diameter of a cable supplying laser spark plug 200 with energy in the form of pumping light or control signals.

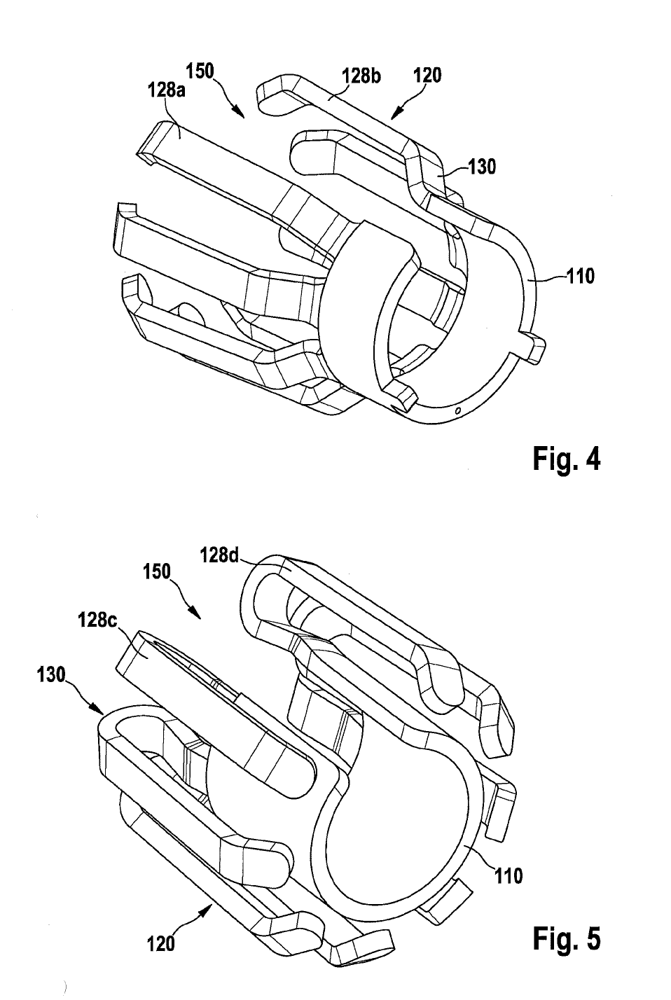

FIG. 4 shows in a perspective view a specific embodiment of cooling device 100 corresponding to the upper half of FIG. 2a, which has multiple arm-shaped structures 128a, 128b, arranged circumferentially.

FIG. 5 shows a similar specific embodiment of the cooling device, in which the arm-shaped structures 128c, 128d, . . . are bent over, however, whereby a generally U-shaped configuration is obtained.

Both the arm-shaped structures 128a, 128b, . . . as shown in FIG. 4, as well as the U-shaped structures 128c, 128d, . . . as shown in FIG. 5, effect by their spring effect or elasticity in turn the radial restoring forces advantageous for the principle of the present invention, which allow for an optimized pressing of the respective contact areas 110, 120 onto laser spark plug 200 or the heat sink such as for example spark plug hole 300.

The lower half of FIG. 2a shows another specific embodiment of the cooling device according to the present invention, in which generally two arm-shaped structures establish a thermal contact between housing 202 of the laser spark plug and inner wall 300b (FIG. 1) of spark plug hole 300. The two arm-shaped structures are mutually connected by a thermally insulating connection 120c, which prevents an undesired heat flow from the relatively hot end 200a of laser spark plug 200 facing the combustion chamber to the normally cooler end 202b of laser spark plug 200 facing away from the combustion chamber. In this specific embodiment, the first contact area 110 is formed by two partial areas 110a, 110b, which are spatially and thermally separated from each other. Partial areas 110a, 110b are connected via first and second connecting means 130a, 130b to their respectively corresponding partial areas 120a, 120b of second contact area 120. If on section 110b a force is exerted radially in the direction of the combustion chamber, then this effects an axial bracing of the device when mounting laser spark plug 200 in the cylinder head and therefore in turn an advantageous spring effect between components 110a, 120a, 110b, 120b in the radial direction. Force may be exerted, e.g., by a screw cap.

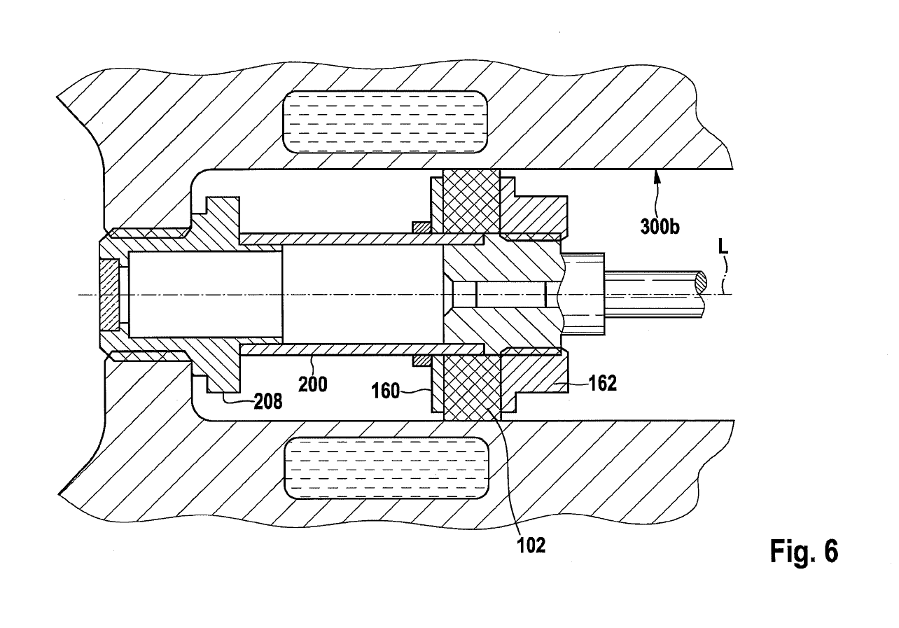

FIG. 6 shows another variant of the cooling device according to the present invention, in which the cooling device is developed at least in part as a stuffing box.

In the present case, the stuffing box is formed by a first stop 160 and a press nut 162. Between stop 160 and press nut 162 there is an elastic, heat-conductive medium such as a copper meshwork or heat-conducting silicone, which represents the packing 102 of the stuffing box. As soon as press nut 162 is screwed onto the screw thread 164 attached on housing 202 of laser spark plug 200 and thus moves in the axial direction toward stop 160, the copper meshwork forming the packing 102 of the stuffing box is pressed in the radial direction inward and outward, whereby corresponding first and second contact areas to housing 202 of laser spark plug 200 and inner surface 300b of spark plug hole 300 are defined.

It is also possible to provide a stuffing box having multiple subdivided chambers, each containing one packing 102, for example at an angular distance of about 20°. The angular range of about 20° remaining between the chambers may then be used advantageously to provide perforations in the stop that is connected to laser spark plug 200 preferably in a rotationally fixed manner such that laser spark plug 200 may be screwed by a special tool using the stop. In this case, a catch profile 208 is no longer required in the end region facing the combustion chamber (FIG. 6 left), and the segmented stuffing box or its stop 160 may act as a catch profile or catch mechanism.

The cooling device according to the present invention may be connected to laser spark plug 200 or its housing 202 in a detachable or non-detachable fashion.

It is furthermore possible for laser spark plug 200 to have, in an end region facing the combustion chamber, a screw thread for screwing it into a target system, in particular a cylinder head, and for it to have, in an end region facing away from the combustion chamber, a catch profile for screwing the laser spark plug into and out of the target system.

The provision of multiple cooling devices 100 in sequence on a laser spark plug 200 is likewise possible. For example, a first cooling device may be situated in the area of the spark plug seat, while a second cooling device is situated in the area facing away from the combustion chamber.

It is also possible to insert the laser spark plug into the cylinder head and to brace it (e.g. using a bracket), instead of screwing it into the cylinder head. This variant advantageously allows for the cooling device(s) to be mounted on the laser spark plug prior to installation into the cylinder head.

The cooling device as shown in FIG. 4, 5 may be manufactured particularly favorably as a stamped and bent part from a material that has good spring properties and heat-conducting properties such as copper or brass or an aluminum alloy for example. The bending of the arms 128a, 128b, 128c, 128d, . . . is preferably to be developed in such a way that the radially outer contact areas 122, of the arms 128a, 128b, 128c, 128d, . . . initially (prior to mounting in the spark plug hole) form a somewhat greater diameter than the inner diameter of the spark plug hole. The arms are thereby advantageously pre-stressed during the installation in the spark plug hole, which results in contact pressure forces that promote thermal conduction.

Preferred geometries for the cooling device or the arms take into account the following points:
shortest possible path between contact areas 110, 120, i.e. connecting means 130 should have the shortest possible length,
greater total contact area in the radially outer second contact area 120 than in the radially inner first contact area 110, since the surface contact between components 122, 300b is possibly not as close as between components 202, 110,
development of arms 128a, 128b, . . . such that their contact surfaces 122 in the installed position contact inner surface 300b of the spark plug hole over the entire surface if possible,
providing for a stop 110c, for example on housing 202 (FIG. 2a), which limits a relative movement between cooling device 100 and laser spark plug 200 in the axial direction,
choose the angular distance between adjacent arms in such a way that it is possible to reach with a special tool behind the arms in order to pull off the cooling device from a laser spark plug 200 that is still installed.

In another specific embodiment, the cooling device has a housing that is elastic at least in the radial direction and a heat-conducting medium enclosed within this housing, e.g., according to the principle of a heat pipe.

1-13. (canceled)

14. A cooling device for a laser spark plug, comprising:
a radially inner first contact area which is configured to establish a thermal contact to a housing of the laser spark plug via at least one first radially inner contact surface;
a radially outer second contact area which is configured to establish a thermal contact to an inner wall of a spark plug hole receiving the laser spark plug via at least one first radially outer contact surface; and
a connector to establish a thermal contact between the first contact area and the second contact area;
wherein the cooling device is at least in part elastic to allow for a relative movement in a radial direction between at least the first contact surface and the second contact surface.

15. The cooling device as recited in claim 14, wherein the first contact area has at least in part one of a hollow-cylindrical shape or a conical basic shape.

16. The cooling device as recited in claim 14, wherein a radially outer contact surface of the second contact area is greater than or equal to a radially inner contact surface of the first contact area.

17. The cooling device as recited in claim 14, wherein the first contact area and the second contact area and the connector are formed as one piece from a same, highly heat-conductive material.

18. The cooling device as recited in claim 17, wherein the material is one of copper or a Cu alloy.

19. The cooling device as recited in claim 14, wherein a radially inner surface of the second contact area has a spring acting at least partially in a radial direction, which is developed and situated in such a way that the spring applies a spring force at least one of: on the second contact area against the first contact area, and in an installed state of the cooling device against a housing of the laser spark plug.

20. The cooling device as recited in claim 14, wherein the cooling device is, at least in sections, a stuffing box, a packing of the stuffing box being made up of an elastic heat-conductive material which forms at least in part at least one of the first contact area, the second contact area, and the connector.

21. The cooling device as recited in claim 15, wherein the cooling device has a slot extending in an axial direction of the first contact area.

22. The cooling device as recited in claim 14, wherein at least one first radially outer contact surface has at least in sections a surface shape that corresponds to a jacket surface of a circular cylinder.

23. The cooling device as recited in claim 14, wherein the radially outer second contact area has an axial end section which points radially inward in such a way that a longitudinal axis encloses an angle between approximately 2° and approximately 45° with a longitudinal axis of the laser spark plug.

24. The cooling device as recited in claim 14, wherein the radially outer contact area has a plurality of at least one of arm-shaped and U-shaped structures, longitudinal axes of which, at least in an installed position, extend around the laser spark plug and in a spark plug hole in parallel to a longitudinal axis of the laser spark plug.

25. The cooling device as recited in claim 14, wherein the first contact area has at least two partial areas that are situated so as to be thermally separated from each other; the second contact area has at least two partial areas, which are connected to each other via a thermally insulating connecting piece, a first partial area of the first contact area is connected to a first partial area of the second contact area via a first connector, and a second partial area of the first contact area is connected to a second partial area of the second contact area via a second connector.

26. A laser spark plug having at least one cooling device, the at least one cooling device including a radially inner first contact area which is configured to establish a thermal contact to a housing of the laser spark plug via at least one first radially inner contact surface, a radially outer second contact area which is configured to establish a thermal contact to an inner wall of a spark plug hole receiving the laser spark plug via at least one first radially outer contact surface, and a connector to establish a thermal contact between the first contact area and the second contact area, wherein the cooling device is at least in part elastic to allow for a relative movement in a radial direction between at least the first contact surface and the second contact surface, wherein the cooling device is connected to the laser spark plug in one of a detachable or non-detachable fashion.

27. The laser spark plug as recited in claim 26, wherein in an end region facing a combustion chamber, the laser spark plug has a screw thread for screwing into a cylinder head, and in an end region facing away from the combustion chamber, the laser spark plug has a catch profile for screwing the laser spark plug into and out of the cylinder head.
